(19) United States
(12) Patent Application Publication
(10) Pub. No.: US 2024/0126282 A1
(43) Pub. Date: Apr. 18, 2024

(54) SYSTEMS, METHODS, AND APPARATUSES FOR SECURELY AUTHENTICATING DEVICE USAGE AND ACCESS

(71) Applicant: Robb Takeshi Fujioka, Manhattan Beach, CA (US)

(72) Inventor: Robb Takeshi Fujioka, Manhattan Beach, CA (US)

(21) Appl. No.: 18/237,277

(22) Filed: Aug. 23, 2023

Related U.S. Application Data
(63) Continuation of application No. 17/491,545, filed on Oct. 1, 2021, now abandoned.
Application No. 17/491,545 is a continuation of application No. PCT/US20/25840, filed on Mar. 30, 2020.
(60) Provisional application No. 62/827,399, filed on Apr. 1, 2019.

(51) Int. Cl. G05D 1/228; G05D 1/223; G05D 1/226; G06F 1/16

(52) U.S. Cl. CPC G05D 1/228; G05D 1/223; G05D 1/226; G06F 1/163

(57) ABSTRACT

Provided herein are embodiments of systems, methods, apparatuses, computer program products, and techniques associated with authenticating usage of, and access to, various target devices. In some embodiments, these systems, methods, apparatuses, computer program products, and techniques may be configured to facilitate compliance with predetermined requirements or restrictions, for example age restrictions, associated with the use or sale of certain devices and products.

### CROSS-REFERENCE TO RELATED APPLICATIONS

The present application is a continuation of U.S. patent application Ser. No. 17/491,454, filed Sep. 30, 2021, which is a continuation of PCT International Application No. PCT/US20/25840, filed Mar. 30, 2020, which claims priority to U.S. Provisional Application No. 62/827,399, filed Apr. 1, 2019, the disclosures of which are hereby incorporated by reference in their entireties.

### FIELD

The subject matter described herein relates generally to systems, methods, apparatuses, and techniques for securely authenticating access and usage of devices.

### BACKGROUND

Various devices offered in the marketplace are subject to age restrictions. For example, age restrictions may be applied to adult-oriented devices such with electronic cigarettes (or “e-cigarettes”), vaporizers, tobacco products, etc. Age restrictions may prohibit individuals under certain ages from purchasing, accessing, or using these devices. Likewise, age restrictions may be imposed on toys, electronic games, video games, and other devices that collect personal information concerning children. In certain cases, parental consent may be required before children are able to utilize such devices.

The age restrictions imposed on products and services can vary across jurisdictions. In the United States, various federal and state laws prohibit sale or use of certain products to or by individuals under a certain age (e.g., under 18 or 21 years of age). In addition, the Children's Online Privacy Protection Act (COPPA) imposes certain requirements on operators of websites or online services directed to children under 13 years of age, and on operators of websites or online services that collect personal information concerning children under 13 years of age. Similarly, Similarly, the Health Insurance Portability and Accountability Act (HIPPA) imposes certain restrictions on the collection of medical information from children and minors. Likewise, in the European Union, the General Data Protection Regulation (GDPR) also imposes various restrictions on collecting child data and obtaining consent from parents. Failure to properly comply with the applicable age restrictions imposed by these and other legislative schemes can subject companies to liability and, in some cases, result in criminal penalties.

Thus, needs exist for systems, methods, apparatuses, computer program products, and techniques associated with authenticating usage of, and access to, various target devices without the above mentioned and other disadvantages.

### SUMMARY

Provided herein are example embodiments of systems, methods, apparatuses, computer program products, and techniques associated with authenticating usage of, and access to, various target devices. In some embodiments, these systems, methods, apparatuses, computer program products, and techniques may be configured to facilitate compliance with age restrictions associated with the use or sale of certain devices and products. For example, the authentication systems may be configured to perform age verification functions that validate that individuals seeking to access, purchase, and/or use target devices are above a certain age, and/or that verify parental approval of underage individuals accessing, purchasing, and/or using the target devices. In certain embodiments, the authentication systems may control functions of the target devices (e.g., to activate/deactivate components and functions associated with such devices), e.g., based on whether or not the authentication and/or age verification requirements have been satisfied. The configurations and functionality of the authentication systems may vary based on the age restrictions that apply to such target devices and/or the configurations of the target devices.

In some embodiments, the present disclosure may include a system for authenticating and controlling access and usage of a target device, comprising: a verification device coupled to the target device, the verification device comprises at least one or more controllers, one or more communication components and one or more device components; and wherein the verification device is configured to: pair with a mobile device coupled to the target device over a communication network; create an encrypted communication channel with the mobile device; synchronize with the mobile device using the encrypted communication channel; and enable the target device.

In some embodiments, the target device is one of e-cigarette, e-vaporizer, IoT device, toy and medical device. In some embodiments, the device components may include at least one of sensors, heating elements, batteries, controllers, memory devices, transceiver devices, circuits, e-liquid cartridges, microphones, speakers, and input/output devices. In some embodiments, the sensors may include at least one of acoustic sensors, sound sensors, video sensors, touch sensors, magnetic contact sensors, heat sensors, gas sensors, smoke sensors, pressure sensors, infrared (IR) sensors, proximity sensors, light sensors, temperature sensors, and imaging sensors.

In some embodiments, the mobile device is in a predetermined proximity with the verification device for the pairing.

In some embodiments, an application is located at the mobile device. The application may be configured to validate an age of a user and create an encrypted verification file in accordance with at least one predetermined requirement, including requirement of COPPA, HIPPA, GDPR, and PCI.

Other features and advantages of the present invention are or will become apparent to one skilled in the art upon examination of the following figures and detailed description, which illustrate, by way of examples, the principles of the present invention.

The systems, methods, and apparatuses for authenticating usage of, and access to, various target devices described herein in detail are only example embodiments and should not be considered limiting. Other configurations, methods, features and advantages of the subject matter described herein will be or will become apparent to one with skill in the art upon examination of the following figures and detailed description. It is intended that all such additional configurations, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 illustrates an overview of an exemplary authentication system, according to some embodiments of the present disclosure.

FIG. 2 illustrates method for securely establishing an age gate using an authentication system, according to some embodiments of the present disclosure.

FIG. 3 illustrates method of using an age gate that has been activated on a target device, according to some embodiments of the present disclosure.

FIG. 4 illustrates a method of setting up a target device, according to some embodiments of the present disclosure.

FIG. 5 illustrates an exemplary overall platform in which various embodiments and process steps can be implemented, according to some embodiments of the present disclosure.

### DETAILED DESCRIPTION

Generally, the present disclosure provides embodiments of systems, methods, apparatuses, computer program products, and techniques associated with authenticating usage of, and access to, various target devices. In some embodiments, these systems, methods, apparatuses, computer program products, and techniques may be configured to facilitate compliance with predetermined requirements or restrictions, for example age restrictions, associated with the use or sale of certain devices and products. In an example, the present disclosure may be configured to perform age verification functions that validate that individuals seeking to access, purchase, and/or use target devices are above a certain age, and/or that verify parental approval of underage individuals accessing, purchasing, and/or using the target devices. In some embodiments, the present disclosure may control functions of the target devices (e.g., to activate/deactivate components and functions associated with such devices), e.g., based on whether or not the authentication and/or age verification requirements have been satisfied. The configurations and functionality of the present disclosure may vary based on the age restrictions that apply to such target devices and/or the configurations of the target devices. The present disclosure may be referred to herein as authentication systems.

In some embodiments, the authentication systems described herein may be utilized in connection with any target device that is subject to access restrictions (including age). For example, in certain embodiments, the target devices may correspond to electronic cigarettes and/or electronic vaporizers which are subject to various federal and/or state law regulations that prohibit individuals under certain ages from purchasing and/or using such devices. The target devices may additionally, or alternatively, include Internet of Things (IoT) devices that are capable of collecting information associated with children. For example, in many cases, IoT devices may be integrated into certain toys or other products marketed to children and may collect information associated with the children. The target devices may additionally, or alternatively, include medical devices and equipment that are capable of collecting information that is subject to regulation (e.g., medical information and/or other information that is subject to privacy restrictions or concerns protected individuals such as children and minors).

In some embodiments, the authentication systems described herein may be utilized to verify or enhance compliance with any age restrictions associated with the target devices utilizing the methods set forth in this disclosure. Exemplary age restrictions may relate to minimum age requirements for accessing, purchasing, and/or using the target devices. Other types of age restrictions may relate to requirements associated with collecting and/or using personal information associated with children, minors, or individuals of particular ages. In some cases, the age restrictions may require parental approval for accessing, purchasing, and/or using target devices. In certain embodiments, the authentication systems described herein can be utilized to verify age restrictions imposed by the COPPA, GDPR, and/or HIPPA. The authentication systems described herein can be used to verify or enhance compliance with age restrictions imposed by these and/or other regulatory schemes.

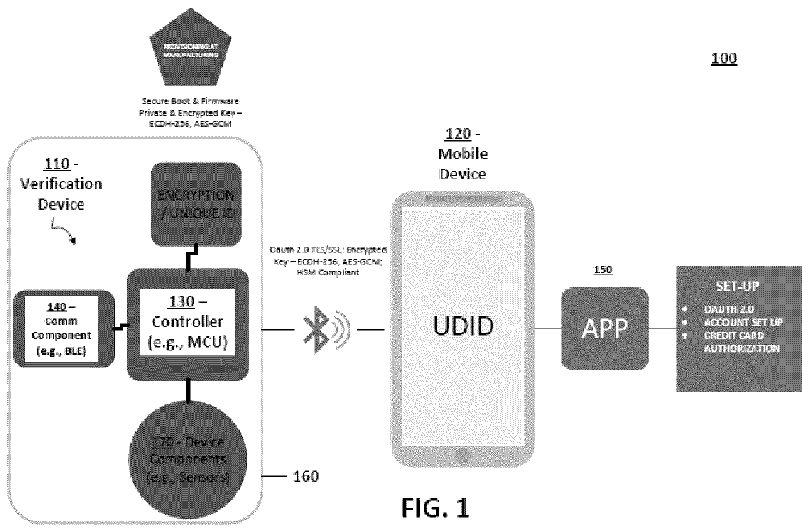

Turning now to the drawings, FIG. 1 discloses an exemplary authentication system 100 according to certain embodiments. The authentication system 100 may include one or more verification devices 110 and/or one or more mobile devices 120. The verification devices 110 may be integrated into, or otherwise coupled to, target devices 160 which are subject to age restrictions. In some embodiments, the verification devices 110 may pair with mobile devices 160 (and/or applications installed thereon) to execute age validation functions that serve to facilitate compliance with any applicable age restrictions pertaining to the target devices 160. As explained in further detail below, one or more functions and/or one or more components of the targets devices 160 may be rendered inoperable, or partially inoperable, until the authentication system 100 validates compliance with age restrictions associated with the target devices 160.

In some embodiments, the verification devices 110 may be integrated into the target devices 160 during manufacturing of the target devices 160. In other embodiments, the targeted devices 160 can be retrofitted with the verification devices 110.

In some embodiments, each verification device 110 may include one or more controllers 130 and one or more communication components 140. Exemplary controllers 130 included in the verification devices 110 can include microcontrollers (MCUs), microprocessors, central processing units (CPUs), complex instruction set computing (CISC) microprocessors, reduced instruction set computing (RISC) microprocessors, very long instruction word (VLIW) microprocessors, graphics processors, digital signal processors, and/or other types of processors or processing circuits capable of performing desired functions. The communication components 140 included in the verification devices 110 may include any type of wired or wireless communication component. Exemplary wireless communication components can include transceiver devices, transmitters, receivers, antennae, and/or the like. Exemplary wired communication components can comprise wired communication hardware including, for example, one or more data buses, such as, for example, universal serial bus(es), one or more networking cables, such as, for example, coaxial cable(s), optical fiber cable(s), Ethernet cables, and/or twisted pair cable(s), any other suitable data cable, etc. The wired and/or wireless communication components 140 can be implemented using any one or any combination of wired and/or wireless communication protocols, e.g., personal area network (PAN) protocol(s), local area network (LAN) protocol(s), wide area network (WAN) protocol(s), cellular network protocol(s), etc. Exemplary PAN protocols can comprise Bluetooth, Zigbee, Wireless Universal Serial Bus (USB), Z-Wave, etc. Exemplary LAN and/or WAN protocol(s) can comprise: Institute of Electrical and Electronic Engineers (IEEE) 802.3 (also known as Ethernet), IEEE 802.11 (also known as WiFi), etc. In many embodiments, the communication components 140 included in the verification devices can be implemented using a System-on-a-Chip (SoC) configuration, such as a Bluetooth Low Energy (BLE) chipset that includes both the RF transceiver and a microcontroller running a Bluetooth stack (firmware) all in a single chip.

The communication components 140 of verification devices 110 may be configured to communicate with one or more mobile devices 120 to assist in complying with age restrictions associated with target devices 160. Exemplary mobile devices 120 can include a portable electronic device (e.g., an electronic device conveyable by hand by a person) with the capability to present audio and/or visual data (e.g., text, images, videos, music, etc.). For example, a mobile device 120 can comprise at least one of: a cellular telephone (e.g., a smartphone), a personal digital assistant, a handheld digital computer device (e.g., a tablet computer device), a laptop computer device (e.g., a notebook computer device, a tablet device, a netbook computer device), a wearable user computer device, and/or other portable computer device with the capability to present audio and/or visual data (e.g., images, videos, audio, etc.).

In some embodiments, the verification device 110 associated with a target device 160 may pair with a mobile application 150 installed on a mobile device 120 using a secure, encrypted communication channel as described in further detail below. Upon pairing the verification device 110 and the mobile device 120, the mobile application 150 may be configured to execute one or more age validation functions to confirm compliance with any applicable age restrictions associated with the target device 160. The age validation functions may include one or more of following examples: executing a credit card transaction; executing a credit rating age verification function (e.g., which validates an individual's age using credit agency information); and/or executing a vehicle records age verification function (e.g., which validates an individual's age using Department of Motor Vehicles or DMV records). Other types of age validation functions may also be executed to facilitate compliance with age restrictions.

In the event that the age validation functions confirm that age restrictions are satisfied (e.g., confirm the individual in possession of the target device is of an appropriate age or confirm parental approval for using the target device), the mobile device may be synced with the verification device 110 and the mobile device 120 may transmit a synchronization signal to the target device 160 that may enable the target device 160 to be activated and/or utilized by an individual in possession of the target device 160. In the event that the age validation functions fail to confirm that age restrictions are satisfied (e.g., do not confirm the individual in possession of the target device is of an appropriate age or do not confirm parental consent for using the target device), the mobile device 160 may not be synced with the verification device 110 and the target device 160 cannot be utilized for at least one or more intended functions.

In some embodiments, the target devices 160 may be configured to switch between a non-active mode and an active mode. For example, upon manufacturing a target device 160, the target device 160 may be configured in a non-active mode. In the non-active mode, one or more functions and/or components 170 may deactivated or otherwise not available for use. In response to the authentication system 100 validating compliance, for example with age restrictions, associated with the target device 160, a synchronization signal may be sent to the verification device coupled to the target device 160 to cause the target device 160 to transition from the non-active mode to an active mode. In the active mode, one or more of the deactivated functions and/or deactivated components 170 may be activated, thus enabling the target device to function.

In some exemplary embodiments involving target devices 160 related to e-cigarettes or e-vaporizers, a heating element included in such devices may be deactivated when the target device 160 is configured in a non-active mode and the heating element may be activated when the target device 160 is configured in an active mode. In some exemplary embodiments involving target devices 160 related to IoT devices (e.g., IoT-based toys), one or more sensors included in such devices may be deactivated in a non-active mode and the one or more sensors may be activated in an active mode. Exemplary sensors can include one or more of the following: acoustic sensors, sound sensors, video sensors, touch sensors, magnetic contact sensors, heat sensors, gas sensors, smoke sensors, pressure sensors, infrared (IR) sensors, proximity sensors, light sensors, temperature sensors, imaging sensors, and/or other types of sensors. Other components 170 (e.g., batteries, controllers, memory devices, transceiver devices, circuits, e-liquid cartridges, microphones, speakers, input/output devices, etc.) and/or functions of the target devices 160 (e.g., e-cigarettes, e-vaporizers, IoT devices, and toys) may also be activated/deactivated by switching between non-active and active modes. Additionally, the functions and components 170 associated with other types of target devices (e.g., medical devices) can be activated and deactivated in a similar manner by switching between modes.

As mentioned above, the target devices may be paired to mobile devices 120 using a secure encrypted communication channel. In some embodiments, the pairing process may utilize a “one-to-one” pairing protocol that restricts the pairing of a particular target device 160 to a single mobile device 120 with a single downloaded mobile application 150, and a single account associated with the mobile application and mobile device 120. In other words, once a target device is synched with a mobile device 120, application 150 and account (which may occur after confirmations that age-restrictions are properly complied with), only that mobile device 120, application 150 and account can communicate with the target device 160 and/or enable use of the target device 160. This one-to-one pairing protocol can be useful for ensuring that the target device 160 is not then transferred to, or utilized by, other minors or other individuals whose age has not been validated using the authentication system 100.

In some embodiments, to facilitate the one-to-one pairing process, a mobile device 120 and a target device 160 may each include a unique set of credentials. For example, target device credentials can be established by combining an encryption key and a unique identifier (ID) that is preprogrammed into the verification device 110 associated with the target device 160. Similarly, mobile device credentials can be established by a combining a unique device identifier (UDID) associated with the mobile device 120 with an encryption key that is provided by the mobile application 150 installed on the mobile device 120.

In some embodiments, the one-to-one pairing process may be initiated when the mobile device 120 and the target device 160 are within a certain proximity (e.g., placed within 24 inches, 12 inches, 6 inches, or other distance) of one another. Requiring that the mobile device 120 and the target device 160 may only be paired when they are within a certain proximity of one another can help to further ensure compliance with other applicable requirements (e.g., age requirement) associated with the target device 160. Upon the mobile device 120 and the target device 160 being within proximity of one another, the mobile device 120 and the target device 160 may pair via an encrypted channel. In certain embodiments, the encrypted channel may be established by utilizing the communication component 140 of the verification device 110 to broadcast a network, detecting the network on the mobile device 120, and coupling the mobile device 120 to the target device 160 via the broadcasted network. In certain embodiments, the pairing process may be performed, at least in part, using a Bluetooth chipset included in the verification device 110 and limiting the range of the network broadcast by the chipset. Once paired, in some embodiments, only the mobile device 120 (and/or its mobile application) may communicate with the target device 160.

After pairing of the devices, the mobile application 120 may prompt an individual operating the mobile device 120 to perform one or more of the aforementioned validation functions (e.g., to conduct a credit card transaction for age validation). The validation functions may provide added confidence. For example, the age validation functions can provide added confidence that the individual in possession of the target device 160 and/or mobile device 120 is of an appropriate age and/or that parental consent has been given to use the target device 160. Upon successfully performing the one or more age validation functions, a synchronization signal can be sent from the mobile device 120 to the target device 160. The synchronization signal can be utilized to activate functions and/or components 170 (e.g., heating elements and/or sensors) of the target device 160. For example, upon receiving the synchronization signal, the verification device 110 coupled to the target device can activate the target device 160 by switching from a non-active mode to an active mode.

In some embodiments, after a target device 160 is synced with a mobile device 120 using the authorization system, the target device may be configured to be fully operational throughout the remainder of its life. That is, only a single authentication may be required to enable functioning of the target device 160. In other embodiments, authentication system 100 may be required to continuously sync the mobile device 120 with the target device 160 to enable continuous use of the target device 160. For example, each time an individual desires to use the target device 160, the verification device 110 associated with the target device 160 may require an individual in possession of the target device 160 to comply with age restrictions associated with the target device 160. In other embodiments, the verification device 160 may require validation of age requirements on a periodic basis (e.g., daily, weekly, monthly, or yearly). The frequency at which the mobile device 120 and target device 160 are synchronized can be adapted accordingly to comply with any appropriate requirements and/or legislative standards specifying age-related restrictions for the target device 160.

In some embodiments, after a target device 160 is synced with a mobile device 120, the target device 160 (or particular functions and/or components of the target device) may only be operable when the target device is within a certain proximity (e.g., 5 feet, 10 feet, 25 feet, 100 feet, or 1000 feet) of the target device and/or when the target device is paired with the mobile device. In other embodiments, after a target device 160 is synced with a mobile device 120, the target device 160 (or particular functions and/or components of the target device) will be operable regardless of whether the mobile device 120 is located within a certain proximity of the target device 160.

In some embodiments, the mobile application 150 installed on the mobile device 120 may be configured to transmit data received from the target device (e.g., an IoT device) to one or more third party platforms (e.g., websites and/or online resources) that are accessible via a network and/or transmit data received from the third-party platforms to the target device 160. The network may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks. In some embodiments, the mobile application 150 may utilize OAuth protocols (e.g., OAuth 1.0 and/or 2.0) to transmit and/or receive such data. Configuring the mobile application 150 with the OAuth protocol can provide the mobile application with secure delegated access to server resources and can permit the mobile application to securely transmit data to the third-party servers.

In some embodiments, after a target device 160 has been setup and verification of restrictions (e.g., age restrictions) has been completed, the mobile device 120 may be utilized to control various functions and/or components 170 of the target device 160. The mobile application 150 installed on the mobile device 120 may be configured to display one or more interfaces that include options for controlling the functions and/or components 170. For exemplary embodiments that involve e-cigarettes or e-vaporizers, the mobile application 150 may be configured to control aspects of the heating element (e.g., by throttling the level of heat provided by the heating element). For exemplary embodiments that involve IoT devices, the mobile application 150 may be configured to control sensors incorporated into such devices. The mobile application 150 may be configured to control other components (e.g., batteries, video cameras, still cameras, speakers, microphones, gyroscopes, display screens/devices, etc.) of the target devices as well. The mobile application 150 may also be configured to display one or more interfaces that include information associated with the functioning of the target devices (e.g., battery usage, device settings, current modes of operation, data collected by the devices, audio/video generated by the devices, etc.).

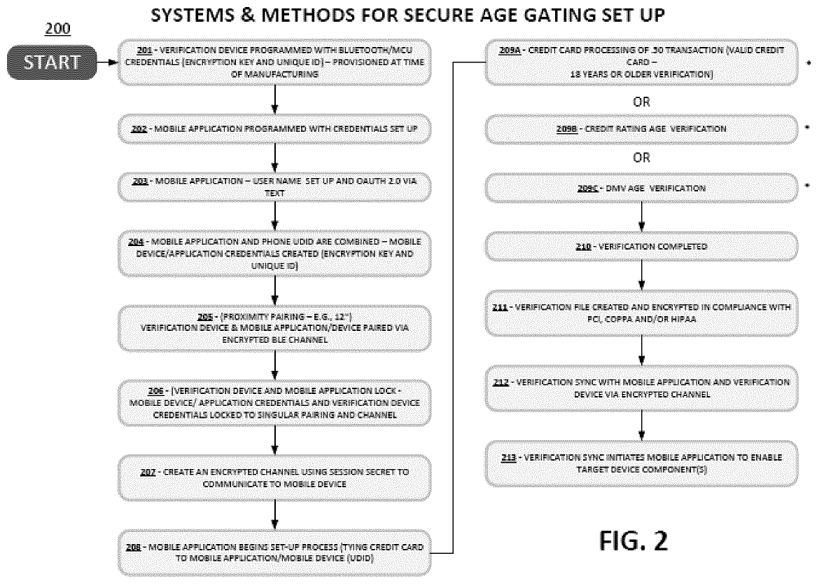

FIGS. 2-4 illustrate flow charts for exemplary methods 200, 300 and 400 according to some embodiments. Methods 200, 300 and 400 are merely exemplary and the invention is not limited to the embodiments presented herein. Methods 200, 300 and 400 can be employed in many different embodiments or examples not specifically depicted or described herein. In some embodiments, the steps of methods 200, 300 and 400 can be performed in the order presented. In other embodiments, the steps of methods 200, 300 and 400 can be performed in any suitable order. In still other embodiments, one or more of the steps of methods 200, 300 and 400 can be combined or skipped. In many embodiments, authentication system 100, verification device 110, and/or mobile device 120 can be suitable to perform methods 200 and 300 and/or one or more of the steps of methods 200, 300 and 400. In these or other embodiments, one or more of the steps of methods 200, 300 and 400 can be implemented as one or more computer instructions configured to run on one or more processors or controllers, and configured to be stored at one or more non-transitory memory storage modules. Such non-transitory memory storage modules can be part of an authentication system 100, verification device 110, and/or mobile device 120.

FIG. 2 discloses an exemplary method 200 for securely establishing an age gate using an authentication system 100 in accordance with certain embodiments.

At step 201, a verification device 110 may be programmed with credentials, e.g., an encryption key and unique ID at the time of manufacturing. In some embodiments, the credentials may be utilized to securely communicate over an encrypted Bluetooth channel. The verification device 110 may be incorporated into a target device 160 (e.g., an e-cigarette, e-vaporizer, IoT device, toy, etc.).

At step 202, a mobile application 150 may be programmed with credentials (e.g., an encryption key). The mobile application 150 may be installed on a mobile device 120.

At step 203, the mobile application 150 may be utilized to authorize or install OAuth protocols (OAuth 1.0 and/or 2.0) and a username. The mobile application 150 may be associated with an account that is associated with the username.

At step 204, credentials may be created for the mobile device 120 and/or mobile application 150. This may involve combining a UDID associated with mobile device hardware with an encryption key provided by the mobile application 150.

At step 205, the verification device 110 may pair with the mobile device 120 and/or application 150 via an encrypted channel. In some embodiments, this encrypted channel may represent an encrypted BLE channel. In some embodiments, the pairing of the verification device 110 with the mobile device 120 and/or application 150 may be initiated when the verification device 110 and mobile device 120 are in proximity with one another (e.g., within 12 inches of one another).

At step 206, the verification device 110 and the mobile device 120 may be locked to singular pairing and channel. As explained above, this may include a “one-to-one” pairing between the target device 160 and mobile device 120.

At step 207, an encrypted channel may be created between the verification device 110 (e.g., the communication component 140) and the mobile device 120 using session secret protocols that enable the verification device 110 to communicate with the mobile device 120.

At step 208, the mobile application 150 may begin a setup process of validating age restrictions associated with the target device 160. This may include authorizing credit card transactions via the account associated with the mobile application, and providing information related to credit card information.

At step 209, one or more age validation functions may be performed to validate age restrictions associated with the target device 160. This may include executed a credit card transaction (step 209A), which may indicate that an individual using the mobile device is at least 18 years old. This can additionally, or alternatively, include performing a credit rating age verification function (step 209B) and/or a DMV age verification function (step 209C).

At step 210, verification may be received by the mobile application 150 indicating that age restrictions associated with the target device 150 have been satisfied.

At step 211, a verification file may be created to confirm compliance with certain legislative-based age restrictions. For example, the verification file may confirm that age restrictions associated with COPPA, HIPPA, GDPR, PCI (Payment Card Industry), and/or applicable legislation has been verified or satisfied. The verification file may be stored in an encrypted format on the mobile device 120 and/or verification device 110.

At step 212, the verification device 110 and mobile device 120 sync to one another in response to verifying age restrictions. This may include establishing an encrypted communication channel between the verification device 110 and/or mobile device 120 using Bluetooth or other communication protocols (e.g., Wi-Fi protocols).

At step 213, the mobile device may transmit a synchronization signal to the verification device 110 which may enable one or more components 170 and/or one or more functions on the target device. In some embodiments, this may involve enabling a heating element or other component, e.g., as in an e-cigarette or e-vaporizer. In some embodiments, this may include enabling one or more sensors, e.g., as included on an IoT device.

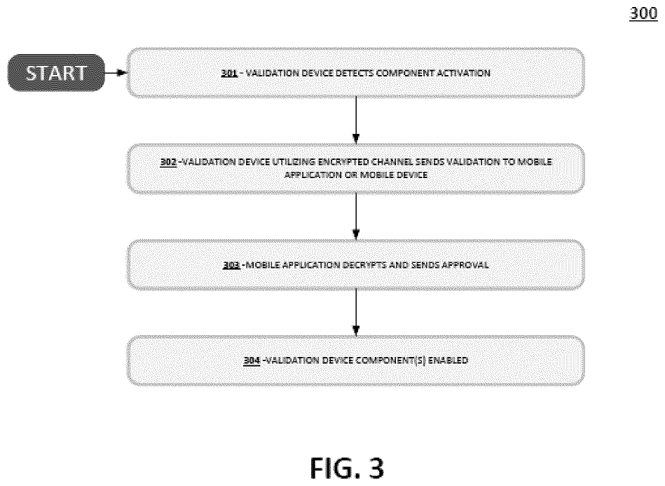

FIG. 3 is a method 300 of using an age gate that has been activated on a target device 160 according to some embodiments.

At step 301, the verification device 110 associated with the target device 160 may detect that a component 170 (e.g., heating element, sensor, etc.) has been activated.

At step 302, the verification device 110 may send a validation signal to the mobile application 150 and/or mobile device 120 using an encrypted channel.

At step 303, the mobile application 150 may decrypt the validation signal and may send an approval signal to the verification device 110.

At step 304, the verification device 110 may enable the component 170. Thereafter, the component may transmit data to the mobile device 120 and the mobile device 120 may relay the data to one or more third-party platforms using, e.g., OAuth protocols.

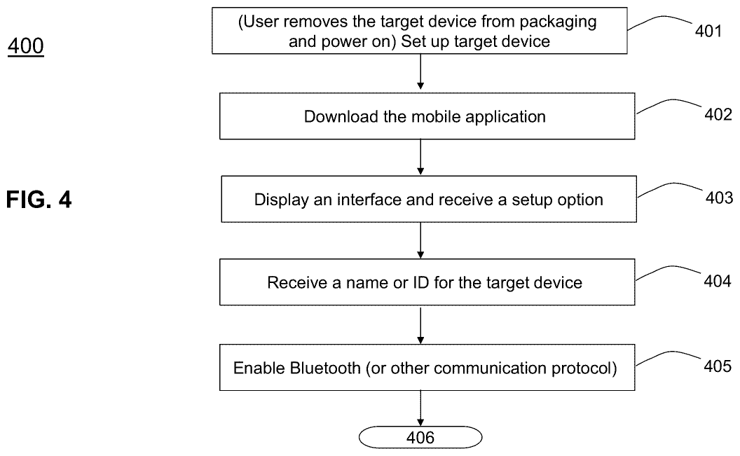

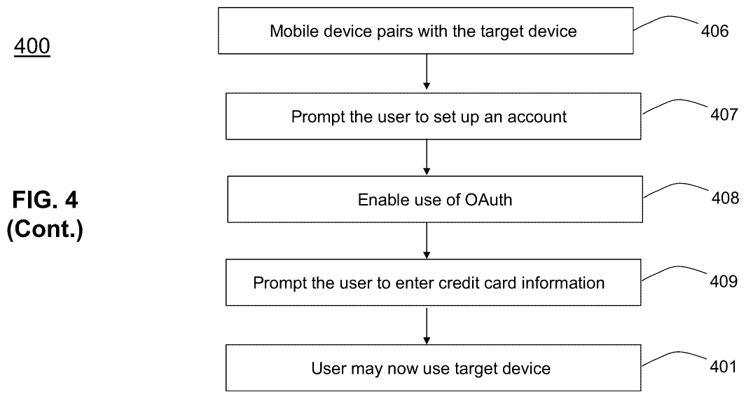

FIG. 4 is a method 400 of setting up a target device 160 according to some embodiments.

At step 401, a user may remove the target device 160 (e.g., e-cigarette, e-vaporizer, IoT device, etc.) from its packaging. The target device 160 may be powered on and a setup mode may initiate on the target device 160 (e.g., a button selected on the target device 160).

At step 402, the mobile device 120 may download the mobile application 150.

At step 403, the mobile application 150 on the mobile device 120 displays an interface and receives a setup option selected by the user.

At step 404, the mobile application 150 receives as input (e.g., from the user) a name or ID for the target device.

At step 405, the mobile device enables Bluetooth (or other communication protocol), e.g., after the user activates the feature.

At step 406, the mobile device 120 pairs with the target device 160. In some embodiments, the user initiates the pairing.

At step 407, the system prompts the user to set up an account associated with a provider of the target device 160. This may include setting up a username and/or password.

At step 408, the system prompts the user to enable use of OAuth 2.0 using the mobile application 150. This may be performed, at least in part, with the system receiving a text message that includes an authorization code.

At step 409, the system prompts the user to enter credit card information into the mobile application 150.

At step 410, the user may use the target device 160.

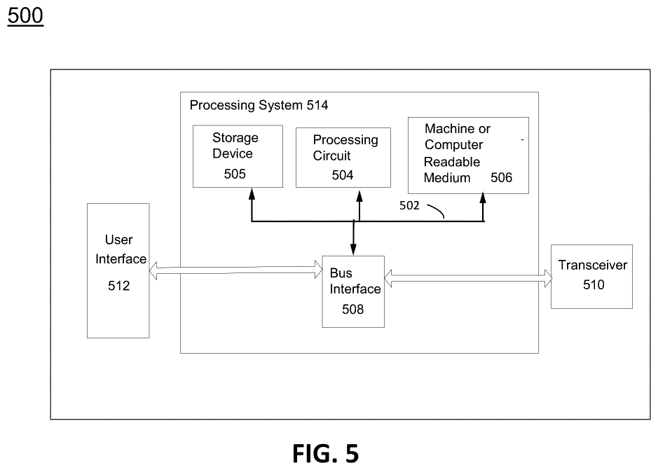

In certain embodiments, the verification devices 110, mobile devices 120, computing devices, and third-party platforms (e.g., which can include servers and/or computing devices hosting websites) disclosed herein can each include one or more storage devices and one or more processors. The one or more storage devices may communicate with the one or more processors and/or controllers, and the one or more processors and/or controllers can execute any instructions stored on the one or more storage devices. The one or more storage devices may include: i) non-volatile memory, such as, for example, read only memory (ROM) or programmable read only memory (PROM); and/or (ii) volatile memory, such as, for example, random access memory (RAM), dynamic RAM (DRAM), static RAM (SRAM), etc. In certain embodiments, the one or more storage devices can comprise (i) non-transitory memory and/or (ii) transitory memory. Further details are disclosed below in FIG. 5.

The verification devices 110, mobile devices 120, computing devices, and third-party platforms can be configured to communicate directly with each other and/or over a network 130 (e.g., a PAN, LAN, WAN, and/or cellular network) via wired or wireless communication links, or a combination of the two.

It should be recognized that while the present disclosure refers to using a “mobile” device and “mobile” application to perform certain functions disclosed herein, any of the functions performed by such mobile devices or applications can alternatively, or additionally, be performed by other types of computing devices (e.g., desktop computers, laptop computers, etc.) and/or applications installed thereon. Thus, any function or use of the mobile devices and/or mobile applications disclosed herein can also be executed by other types of computer devices and/or applications installed thereon.

FIG. 5 illustrates an exemplary overall platform 500 in which various embodiments and process steps disclosed herein can be implemented. In accordance with various aspects of the disclosure, an element, or any portion of an element, or any combination of elements may be implemented with a processing system 514 that includes one or more processing circuits 504. Processing circuits 504 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure, including the process steps 200, 300 and 400 illustrated in FIGS. 2-4. That is, the processing circuit 504 may be used to implement any one or more of the various embodiments, systems, algorithms, and processes described above. In some embodiments, the processing system 514 may be implemented in a server. The server may be local or remote, for example in a cloud architecture.

In the example of FIG. 5, the processing system 514 may be implemented with a bus architecture, represented generally by the bus 502. The bus 502 may include any number of interconnecting buses and bridges depending on the specific application of the processing system 514 and the overall design constraints. The bus 502 may link various circuits including one or more processing circuits (represented generally by the processing circuit 504), the storage device 505, and a machine-readable, processor-readable, processing circuit-readable or computer-readable media (represented generally by a non-transitory machine-readable medium 506). The bus 502 may also link various other circuits such as timing sources, peripherals, voltage regulators, and power management circuits, which are well known in the art, and therefore, will not be described any further. The bus interface 508 may provide an interface between bus 502 and a transceiver 510. The transceiver 510 may provide a means for communicating with various other apparatus over a transmission medium. Depending upon the nature of the apparatus, a user interface 512 (e.g., keypad, display, speaker, microphone, touchscreen, motion sensor) may also be provided.

The processing circuit 504 may be responsible for managing the bus 502 and for general processing, including the execution of software stored on the machine-readable medium 506. The software, when executed by processing circuit 504, causes processing system 514 to perform the various functions described herein for any apparatus. Machine-readable medium 506 may also be used for storing data that is manipulated by processing circuit 504 when executing software.

One or more processing circuits 504 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

It should be understood that exemplary embodiments described above are not intended to be limiting and that the inventive systems, methods, apparatuses, computer program products, and techniques described herein can be used in many other scenarios as well. It should also be further understood that the configurations and structures of the system components in FIG. 1 (e.g., including the verification device 110, target device 160, and mobile device 120) can vary according to different embodiments. For example, while certain components or sub-components may be depicted as being distinct or separate from one another, it should be recognized that this distinction may be a logical distinction rather than a physical or actual distinction. Any or all of the components and sub-components can be combined with one another to perform the functions described herein, and any aspect or feature that is described as being performed by one component or sub-component can be performed by any or all of the other components and sub-components. Likewise, although FIG. 1 may depict a specific number of each component (e.g., a single controller 130, a single communication component 140, a single mobile device 120, a single verification device 110, a single target device 120, etc.), this is not intended to be limiting and the system can include any number of each such component.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

What is claimed is:

1. A system for authenticating and controlling access and usage of a target device, comprising:
a verification device coupled to the target device, the verification device comprises at least one or more controllers, one or more communication components and one or more device components; and
wherein the verification device is configured to:
pair with a mobile device coupled to the target device over a communication network;
create an encrypted communication channel with the mobile device;
synchronize with the mobile device using the encrypted communication channel; and
enable the target device.

2. The system of claim 1, wherein the target device is one of e-cigarette, e-vaporizer, IoT device, toy and medical device.

3. The system of claim 1, wherein the one or more device components include at least one of sensors, heating elements, batteries, controllers, memory devices, transceiver devices, circuits, e-liquid cartridges, microphones, speakers, and input/output devices.

4. The system of claim 3, wherein the at least one of sensors include at least one of acoustic sensors, sound sensors, video sensors, touch sensors, magnetic contact sensors, heat sensors, gas sensors, smoke sensors, pressure sensors, infrared (IR) sensors, proximity sensors, light sensors, temperature sensors, and imaging sensors.

5. The system of claim 1, wherein the mobile device is in a predetermined proximity with the verification device for the pairing.

6. The system of claim 1, wherein creating the encrypted communication channel includes broadcasting a second network.

7. The system of claim 6, wherein the verification device is further configured to couple the target device to the second network.

8. The system of claim 1, wherein the synchronizing includes receiving a synchronization signal from the mobile device.

9. The system of claim 1 further includes an application located at the mobile device.

10. The system of claim 9, wherein the application is configured to validate an age of a user.

11. The system of claim 10, wherein the application is configured to create an encrypted verification file in accordance with at least one predetermined requirement.

12. The system of claim 11, wherein the at least one predetermined requirement is one of COPPA, HIPPA, GDPR, and PCI.

13. The system of claim 10, wherein the application is configured to send a synchronization signal to the verification device.

14. The system of claim 1, wherein the enabling the target device includes activating one or more device components.

15. A computer-based method for authenticating and controlling access and usage of a target device, comprising:
pairing a mobile device to the target device;
creating an encrypted communication channel between the target device and the mobile device;
validating an age of a user;
creating an encrypted verification file in accordance with at least one predetermined requirement;
synchronizing the mobile device with the target device; and
enabling one or more component devices coupled to the target device.

16. The method of claim 15, wherein the target device is one of e-cigarette, e-vaporizer, IoT device, toy and medical device.

17. The method of claim 15, wherein the one or more device components include at least one of sensors, heating elements, batteries, controllers, memory devices, transceiver devices, circuits, e-liquid cartridges, microphones, speakers, and input/output devices.

18. The method of claim 17, wherein the at least one of sensors include at least one of acoustic sensors, sound sensors, video sensors, touch sensors, magnetic contact sensors, heat sensors, gas sensors, smoke sensors, pressure sensors, infrared (IR) sensors, proximity sensors, light sensors, temperature sensors, and imaging sensors.

19. The method of claim 15, wherein the mobile device is in a predetermined proximity with the target device for the pairing.

20. The method of claim 15, wherein at least one predetermined requirement is one of COPPA, HIPPA, GDPR, and PCI.
